(19) United States
(12) Patent Application Publication
(10) Pub. No.: US 2009/0161576 A1
(43) Pub. Date: Jun. 25, 2009

(54) Methods And Systems For Sending Information To A Zone Included In An Internet Network

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/962,285

(22) Filed: Dec. 21, 2007

(51) Int. Cl. H04L 12/28

(52) U.S. Cl. 370/254

(57) ABSTRACT

Methods and systems are described for sending information to a zone included in an internet network. In one embodiment, zone address information identifying a connected region of topology of a given scope included in an internet network is received. The scope is a topological span within which a network address is usable. A message is generated. The message includes a message header including a destination portion including an outside-scope unicast identifier having a zone identifier based on the zone address information. The destination portion does not include a zone network interface portion specified for identifying a network interface of a zone node included in the identified zone. The message is transmitted for routing based on the zone identifier to a border node having an outside network interface for receiving the message and an inside network interface for routing the message to a service.

### BACKGROUND

In today's systems, sending information via the internet can be done via a scoped address. For example, Request for Comments (RFC) 3513 and RFC 4007 describe scoped addresses where a scope defines a size or span of a particular network region or zone for which an address is applicable. A scoped address is used only within a zone of a span indicated by its scope. A message transmitted with a scoped address should not be delivered to any host interface as a communication endpoint where the interface is outside a zone identified by the scoped address. For example, Internet Protocol Version 6 (IPv6) address architecture supports local scopes, such as link-scope and zone-scope; and global-scope. Scoped addresses, as currently specified, provide at least a network interface identifier portion. The scope of an address is increased by providing additional addressing information, widening a scope from a network interface portion until an address has global scope.

Currently three prefixes headers related to scope of unicast addresses are defined according to RFC 3513; a link-local unicast prefix, a site-local unicast prefix, and a global unicast prefix.

Accordingly, there exists a need for methods, systems, and computer program products for sending information to a zone included in an internet network from a network node outside the zone.

### SUMMARY

Methods and systems are described for sending information to a zone included in an internet network. In one embodiment, zone address information identifying a connected region of topology of a given scope included in an internet network is received. The scope is a topological span within which a network address is usable. A message is generated. The message is addressed to a destination specified by an outside-scope unicast identifier having a zone identifier based on the zone address information. The outside-scope unicast identifier does not include a network interface portion specified for identifying a network interface. The message is transmitted for routing via a network path outside the scope of the identified zone based on the zone identifier to a border node having an outside network interface for receiving the message and an inside network interface for routing the message to a service.

According to an aspect, a system for sending information to a zone included in an internet network, includes a communication interface component configured for receiving zone address information identifying a connected region of topology of a given scope included in an internet network. The scope is a topological span within which a network address is usable. The system also includes a message packager component configured for generating a message addressed to a destination specified by an outside-scope unicast identifier having a zone identifier based on the zone address information. The outside-scope unicast identifier does not include a network interface portion specified for identifying a network interface. The system further includes a sending network interface component configured for transmitting the message for routing via a network path outside the scope of the identified zone based on the zone identifier to a border node having an outside network interface for receiving the message and an inside network interface for routing the message to a service.

In another embodiment, a method for sending information to a zone included in an internet network includes receiving via a network path outside the scope of a zone, by an outside network interface of a border node for the zone included in an internet network, a message including a destination portion that includes an outside-scope unicast identifier identifying the zone of the internet network. The destination portion does not include a portion specified for identifying a network interface. In response to receiving the message, extension information is located in the received message identifying an operation to be performed. At least a portion of the message is routed, based on the extension information, to a service for processing.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for sending information to a zone included in an internet network according to an embodiment of the subject matter described herein;

FIG. 2 is a block diagram illustrating a system for sending information to a zone included in an internet network according to another embodiment of the subject matter described herein;

FIG. 3 is a block diagram illustrating a system for sending information to a zone included in an internet network according to another embodiment of the subject matter described herein;

FIG. 4 is a flow diagram illustrating a method for sending information to a zone included in an internet network according to another embodiment of the subject matter described herein; and

FIG. 5 is a block diagram illustrating a system for sending information to a zone included in an internet network according to another embodiment of the subject matter described herein.

### DETAILED DESCRIPTION

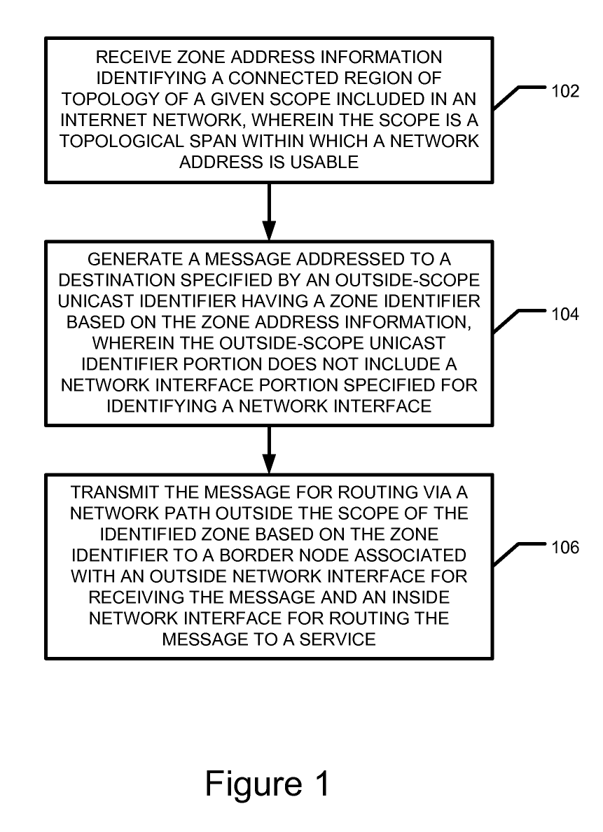

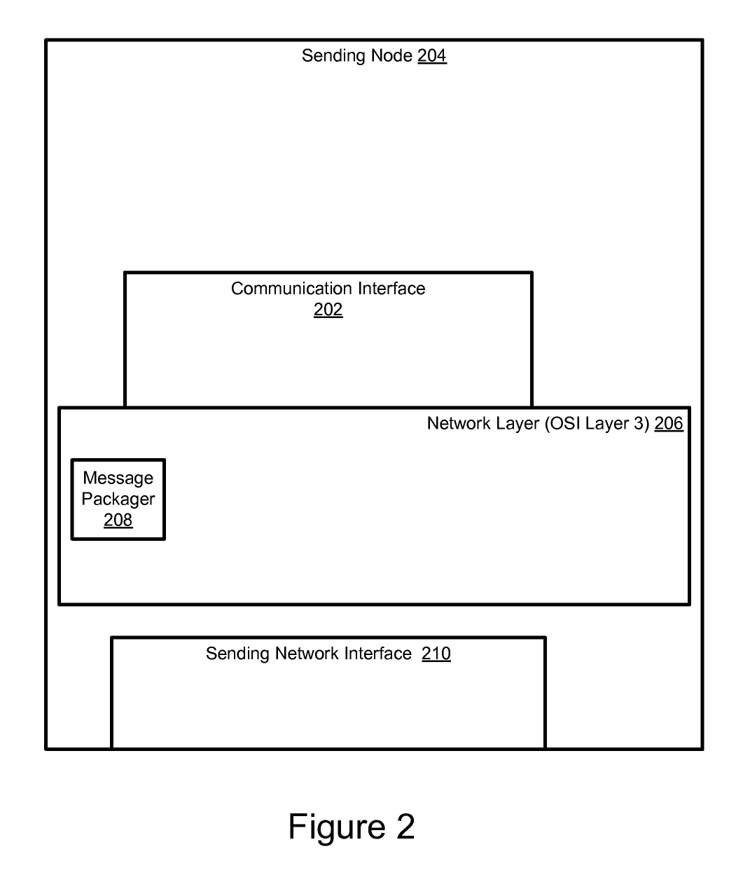

FIG. 1 is a flow diagram illustrating a method for sending information to a zone included in an internet network according to an exemplary embodiment of the subject matter described herein. FIG. 2 is a block diagram illustrating a system for sending information to a zone included in an internet network according to another exemplary embodiment of the subject matter described herein. The method illustrated in FIG. 1 can be carried out by, for example, some or all of the components illustrated in the exemplary system of FIG. 2.

As used herein, the term “internet”, spelled with a lower case “i”, refers to any network made up of a number of networks. Similarly, the term “internet network” refers to a network including one or more of the number of networks making up an internet. As used herein, the term “Internet”, spelled with an upper case “I”, refers to the worldwide interconnected system of networks that connects computers from around the world, most commonly referred to as “the Internet.” The Internet is one example of an internet network.

With reference to FIG. 1, in block 102 zone address information identifying a connected region of topology of a given scope included in an internet network is received. The scope is a topological span within which a network address is usable. Accordingly, a system for sending information to a zone included in an internet network includes means for receiving zone address information identifying a connected region of topology of a given scope included in an internet network. For example, as illustrated in FIG. 2, a communication interface component 202 is configured for receiving zone address information identifying a connected region of topology of a given scope included in an internet network.

For example, the communication interface 202 can be configured to receive an identifier of a zone from an executable component included in a sending node 204. The internet includes a border node including an outside network interface that need not be included in the identified zone. A border node is a node having an outside network interface for receiving, via a network path outside the scope of the identified zone, a packet addressed with an outside-scope unicast address. The border node can be configured to provide for processing the packet sent from a node with a network interface outside the identified zone. An outside network interface has a link to a network interface of a network node outside the identified zone. The border node has an inside network interface. The inside network interface of the border node can be included in the specified zone. The inside network interface is included in a network path including a network interface in the specified zone.

A network address, as currently used, can be an identifier for a network interface or can identify a set of network interfaces. A network address can be a network layer address identifier for a network interface (unicast) or a set of network interfaces (multicast or broadcast). A unicast network address can be specified with a format including a network interface portion and a zone portion. In an Internet Protocol (IP) internet, a subnet portion of an IP address is a zone portion of an IP address. In this document, the remainder of the address is referred to as a network interface portion or an interface portion unless otherwise noted.

As described above, a zone is an instance of a region of an internet of a given scope. Scope is an indicator of a size, span, or boundary of a region. For example, a link-local scope is an address span identifying network interfaces within a single link, such as an Ethernet LAN. A particular Ethernet LAN is a zone. A message sent to a destination address with link-local scope is addressed to a network interface of a network node included in the particular LAN. A global scope is an address span identifying network interfaces anywhere in the internet. An interface-local scope is an address span specific to a network interface of a network node. A site-local scope is an address span identifying network interfaces anywhere within a site. Network interfaces of network nodes that are not included in a zone are outside the zone. An outside-scope is an address span identifying network interfaces outside the scope of a zone.

A scope can both span a first zone and not span a second zone in the first zone. For example, a site-outside-scope is an address span identifying interfaces anywhere inside a particular site and outside an identified zone in the site. Link-outside-scope and interface-outside-scope are defined analogously. The term outside-scope is used to refer to one or all of site outside-scope, link outside-scope, and interface outside-scope unless otherwise noted. Other types of zones can be specified with an associated outside-scope. In general, a span outside of a zone with a given scope is referred to as a zone outside-scope

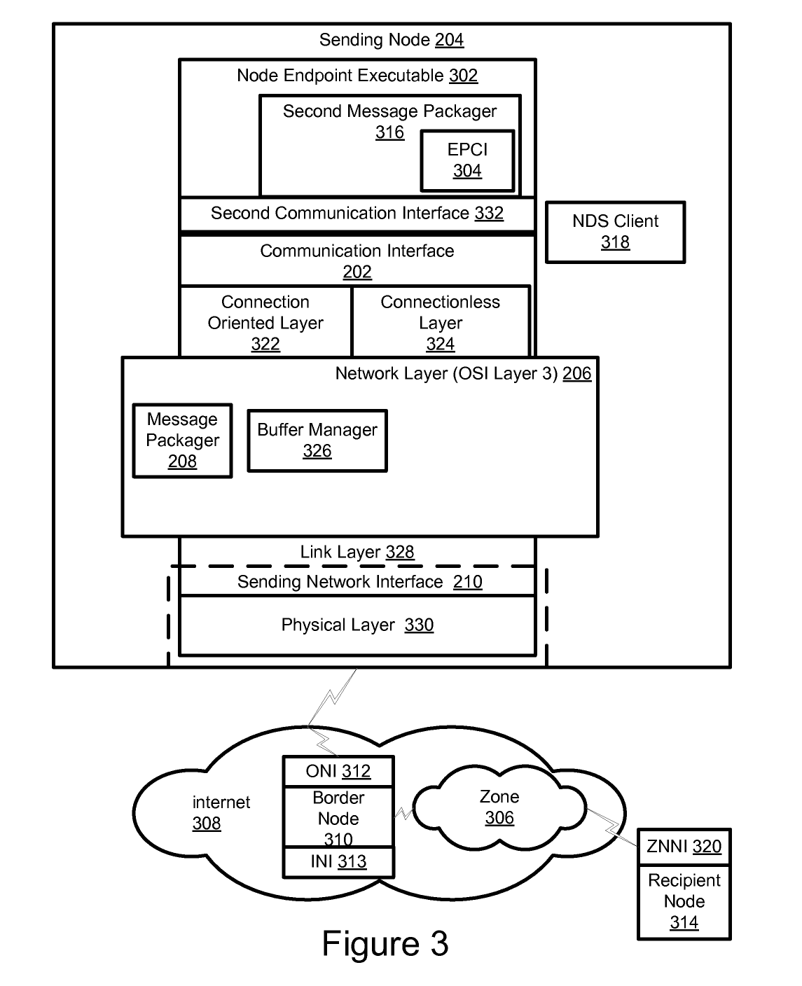

FIG. 3 illustrates an arrangement of components including the components illustrated in FIG. 2. At least a portion of the components included in FIG. 3 can be configured to perform the method 100. In FIG. 3, the sending node 204 includes a node endpoint executable (NEE) 302 operatively coupled to the communication interface 202 via a second communication interface 332. The NEE 302 can include an endpoint communication interface (EPCI) 304 configured to receive an identifier of a zone 306 of an internet 308. The internet 308 can include one or more border nodes 310 of the zone 306. A border node 310 can include one or more outside network interfaces (ONI) 312 that can be outside or in the identified zone 306 as described above.

The identifier of the zone 306 can be generated by the NEE 302, retrieved from a data store by the NEE 302, received via a network such as internet network 308, and/or received via a user interface of the NEE 302. For example, the NEE 302 can receive a Uniform Resource Locator (URL) for accessing a network accessible resource stored in a zone node 314. The NEE 302 includes a second message packager 316 for generating a request for accessing the network accessible resource when provided with the URL. When the second message packager 316 receives the URL, the URL can be provided to the EPCI 304 for detecting and resolving at least a zone portion of a host name included in the URL identifying the zone 306. The EPCI can be configured to interoperate with a network directory service (NDS) client 318, such as a domain name system (DNS) client, to resolve at least a portion of the host name to at least a zone portion of a network address identifying the zone 306.

The host name portion of the URL can include a network interface portion allowing the host name to be resolved to a network address. The network address can be associated with a zone node network interface (ZNNI) 320 included in the zone node 314 associated with a recipient. An identifier of the ZNNI 320 can be included in the message in extension information for specifying an operation to be performed by a recipient. The ZNNI 320 is not included in the outside-scope unicast address with which the message is addressed.

Alternatively, the URL can be specified without a specific network interface identifier of a network node in the zone 306. For example, the URL “http://domain.com/myServer” can identify a naming domain, “domain.com” where no specific network interface is identified by the name, “domain.com”. The naming domain, “domain.com”, can specify a naming zone that can include one or more zones identified by a subnet or zone portion of a network address. When a particular zone node network interface is not identified as the message recipient, extension information can include information identifying an operation to be performed by a service hosted by a zone node and/or a border node.

The EPCI 304 can receive at least a zone portion of the network address corresponding to the at least a zone portion of the host name provided to the NDS client 318. The EPCI 304 can return the at least a zone portion of the network address to the second message packager 316. The second message packager 316 generates a request for transmitting as a message to a border node 310 of the zone 306 identified by the zone portion of the outside-scope unicast network address based on the URL. The request is addressed to a destination specified by an outside-scope unicast identifier including an identifier of the zone 306 in the form of a zone portion in the outside-scope unicast network address. The outside-scope unicast address does not include a network interface portion specified for identifying a network interface.

Alternatively, the EPCI 304 can detect and return a zone portion of the host name that identifies the zone 306 to the second message packager 316. The second message packager 316 can be configured to generate a request for transmitting to a destination specified by the outside-scope unicast address for performing an operation provided by a service in the zone 306 that accesses a resource identified by the URL.

The identifier of the zone 306 can be in any suitable format, including those described above. The zone identifier can be received by the EPCI 304 of the NEE 302. Content for the message can be provided by the second message packager 316. The zone identifier can be received along with or included in the message for transmitting depending on the configuration of the NEE 302. The zone identifier can include a zone portion of a network address and/or a zone portion of a host name in the zone 306.

The zone 306 is illustrated as including the ZNNI 320 of the zone node 314 associated with service configured for performing an operation indicated in the message that can be sent by the NEE 302. For example, the NEE 302 can be configured to provide for identifying a ZNNI identifier. The ZNNI identifier can be identified by providing extension information identifying an operation to be performed accessing a resource, routing at least a portion of the message to a ZNNI of a zone node, such as the ZNNI 320 of the zone node 314, or processing a specified command. The ZNNI identifier can be specified as a name or a network interface portion of a network address, described below. The ZNNI identifier is not included in the destination portion specified as the outside-scope unicast address.

Additional information associated with transmitting and/or processing the message can be provided by the NEE 302. The second message packager 316 can be configured to format a message including one or more of a zone identifier, a network interface identifier, service information, and any additional information for providing to the communications interface 202. Any information not formatted by the second message packager 316 can be provided by the NEE 302 according to its configuration.

The communication interface 202 and/or the second communication interface 332 of the NEE 302 can be configured to determine whether the message will be transmitted using a connection oriented service provided by a connection oriented layer 322, such as Transmission Control Protocol (TCP), or a connectionless service, such as a datagram service, provided by a connectionless layer 324, such as User Datagram Protocol (UDP). Message content and additional information received by the communication layer 202 for transmitting can be stored in one or more buffers managed by a buffer manager 326 in preparation for transmission.

Example 1a below illustrates a format for a unicast network address compatible with a protocol provided by a network layer 206 depicted in FIG. 2. The network layer 206 corresponds to the Open Systems Interconnection (OSI) model layer 3). A unicast Internet Protocol (IP) address is an example unicast network address. The format in Example 1a includes a first portion identifying a zone of an internet network. The first portion is referred to in this document as the zone portion of a network address, such as an IP subnet address. The format includes a second portion the remainder of the address labeled, the interface portion, for identifying a network interface.

One or more routers in the internet 308 can be configured to transmit, based on the zone portion, a message from the sending node 204 to a network interface, referred to as an outside network interface (ONI) 312, of a node, referred to as a border node 310 of the zone 306 identified by the zone portion of the network address. The message is routed via a network path outside the identified zone 306 to the ONI 312 of a border node 310. The ONI 312 is linked to a network interface of a network node outside the zone. The border node 310 includes an inside node path interface 313, also known as an inside network interface (INI), included in a network path coupling the border node to a ZNNI of a zone node in the identified zone 306. The INI 313 can be included in the identified zone 306. Thus, the INI 313 can be a ZNNI. The second portion of the address, when provided in a unicast address, is for a network interface identifier that identifies a network interface of a network node included in the zone. The network interface can be associated with service for performing an operation indicated in the message and/or a message packet. An outside-scope unicast address is formatted such that the network interface portion is not specified for identifying a network interface. Further, the zone portion identifies a zone with a border node for receiving a message addressed to a destination specified by the outside-scope unicast address. The identified zone 306 can include one or more zone nodes.

IPv6 currently provides support for link-local unicast and site-local unicast addresses. Corresponding names for outside-scope unicast addresses used in this document are link-outside unicast and site-outside unicast. Example 1a illustrates a 128-bit addressing structure divided into two portions. The first portion is a zone portion that identifies a region of an internet network. In an outside-scope unicast address the address does not include an interface portion specified for identifying a network interface.

### EXAMPLE 1a

| | |
|---|---|
| n bits | 128-n bits |
| zone portion | interface portion |

Example 1b illustrates an address format including a plurality of zone portions. Each zone portion identifies a zone included in the zone identified by a preceding zone portion except for the first zone portion. An address formatted according to example 1b can also be divided into two portions; a first portion depicted as a zone 1 portion and a second portion, the remainder of the address, depicted as including a zone 2 portion and an interface portion. The first portion identifies a zone including all other zones identifiable in the address. The second portion includes the zone 2 portion and the interface portion. The second portion is referred to as the interface portion in an outside-scope unicast address as stated above, since it can identify a network interface when specified. In an outside scope unicast address, the address does not include an interface portion specified for identifying a network interface.

### EXAMPLE 1b

| | | |
|---|---|---|
| n bits | m bits | 128-n-m bits |
| zone 1 portion | second 2 portion | interface portion |

Any unicast network address that does not include an interface portion specified for identifying a network interface can be specified as an outside-scope unicast address. Thus, as described above, a network address can be both a local-scope unicast address and an outside-scope unicast address, also known as a local-outside scope address. Example 1c illustrates a format for a site-outside-scope network address. In the example, a first n bits are missing, unspecified, or otherwise unused for routing a message to a network interface. The unused portion is followed by a site portion of length m bits that identifies a region in the internet of a site specifying a local scope. The address does not include an interface portion specifying an identifier for a network interface, as indicated by the unused interface portion, specifying an outside-scope. Thus, the address identifies a local zone included in the site zone identified by the site portion. A message sent from a network node in the site zone and outside the identified local zone is routed via a network path in the site zone but outside the identified local zone to a border node of the identified local zone.

### EXAMPLE 1c

| | | |
|---|---|---|
| n bits | m bits | 128-n-m bits |
| unused portion | site portion | unused interface portion |

According to an aspect, a name can be associated with a zone and a name can be associated with a network interface. Thus, an identifier can include a zone portion identifying a zone of the internet by name and a network interface portion identifying a network interface included in the identified zone by name. Names in the current DNS can be assigned where a portion of a host name identifies a zone and a portion identifies a network interface included in the identified zone. For example, the DNS name “placid.nc.sceneralabs.com” can be associated with a network address such that “sceneralabs.com” identifies a first zone. The “nc” name, in the context of the first zone, identifies a second zone included in the first zone. A host name, “placid”, identifies a network interface included in both the first and the second zones

According to another aspect, an identifier can be associated with a format that includes a mixture of a name portion and an address portion where a first portion of the identifier identifies a zone and a second portion identifies a network interface included in the identified zone.

Returning to FIG. 1, in block 104 a message addressed to a destination specified by an outside-scope unicast identifier having a zone identifier based on the zone address information is generated. The outside-scope unicast identifier does not include a network interface portion specified for identifying a network interface. Accordingly, a system for sending information to a zone included in an internet network includes means for generating a message addressed to a destination specified by an outside-scope unicast identifier having a zone identifier based on the zone address information. For example, as illustrated in FIG. 2, a message packager component 208 is configured for generating a message addressed to a destination specified by an outside-scope unicast identifier having a zone identifier based on the zone address information.

For example, in FIG. 2, the communication interface 202 can be configured to store message payload data in a buffer. The buffer along with the zone address information can be provided to the message packager 208. The message packager 208 transforms the message and the zone address information into one or more packets suitable for transmitting. An outside-scope unicast address can be determined including a zone identifier as described above. The zone identifier is based on the zone address information also described above. Alternatively, the zone identifier can be provided to the message packager 208 for determining the outside-scope unicast address or the outside-scope unicast address can be provided to the message packager 208 for generating a message packet. A sending entity operating in the sending node 204, the communication interface 202, the network layer 206, and/or either the message packager 208 or the second message packager 316 can be configured for determining a zone identifier based on received zone address information and/or for determining an outside-scope unicast address including the zone identifier according to the requirements of various configurations of the arrangement of components in FIG. 2.

The message packager 208 can provide a packet header including a destination portion in the packet. The message packager 208 stores, in the packet header, the zone identifier in a zone portion of the destination portion in the form of the outside-scope unicast identifier. The message packager 208 can be configured to fill in other portions of the packet header, but does not include a network interface portion of the destination portion specified for identifying a network interface associated with a recipient.

An indicator can be included in the header indicating that the network interface portion in the destination portion should not be used in routing the packet. Alternatively, the packet header can be formatted without a portion allocated for the network interface portion of the destination portion. The message packet is generated including the packet header and a packet payload including some or all of the message payload data. Extension information identifying an operation to be performed by a service can be included in the message payload and/or in a packet header for identifying a recipient in the identified zone. The service can be hosted in a border node and/or a zone node.

In FIG. 3, one of the connection oriented layer 324 or the connectionless layer 326 included in the communication interface 202 can be configured to store message payload data including upper layer data including connection layer data in a buffer provided by a buffer manager 330. The buffer along with the zone address information is provided to the message packager 208 as described above. The message packager 204 generates a packet header, such as the header in example 2 below. The packet header in example 2 includes a version portion, a traffic class portion, and a flow label portion. A payload length portion indicates the number of bytes in a payload portion of a generated packet. A next header portion indicates an optional header when an optional header is provided. An optional header can include a next header portion allowing multiple optional headers to be included in a packet.

The next header portion is followed by a hop limit portion limiting the number of router hops the packet can traverse before it is discarded. A source address portion includes a network address for identifying the sending network interface (SNI) 210 of the sending node 204. According to an aspect, the packet header includes a source address portion having a source zone portion that identifies a source zone associated with the sending entity. The source address portion can be established to not include a network interface portion specified for identifying a network interface of a zone node associated with the sending entity. That is, the source identifier can be an outside-scope unicast identifier for responding to the message. The source address portion is followed by the destination portion already described. The destination portion illustrated below in Example 2 includes address bits indicating the address type. The message packager 208 can be configured to set the address bits to a predefined setting to indicate the address is an outside-scope unicast address. A zone portion follows the address type portion. The zone portion can be followed by a portion that is unused for including a network interface identifier. That is, there is a network interface portion, but it is unused for specifying a network interface identifier.

Alternatively, the header can be formatted without a network interface portion by the message packager 208. The message packager 208 stores the zone identifier in the zone portion of the destination portion of the packet header. The message packager 208 can be configured to fill in other portions of the packet header, but does not include a network interface portion of the destination portion for specifying an identifier for a network interface.

Example 2 illustrates an IPv6 header generated by a message packager 208 included in the sending node 204 including a SNI 210 identified by the source address portion of the header. The destination address is an outside-scope unicast address as indicated by the eleven bit prefix of ‘1’'s that can be defined for indicating an outside-scope unicast address. The header indicates the message is to be transmitted to any border node 310 of the zone 306 identified by the zone portion of the outside-scope unicast address.

### EXAMPLE 2

IPv6 Header Format from RFC 2460:

| | | |
|---|---|---|
| Version | Traffic Class | Flow Label |

| | | |
|---|---|---|
| Payload Length | Next Header | Hop Limit |

Source Address

| | |
|---|---|
| address bits | zone |
| | portion |

unused for interface identifier or missing

| | |
|---|---|
| Version | 4-bit Internet Protocol version number = 6. |
| Traffic Class | 8-bit traffic class field. |
| Flow Label | 20-bit flow label. |
| Payload Length | 16-bit unsigned integer. Length of the IPv6 |
| | payload, i.e., the rest of the packet following this |
| | IPv6 header, in octets. (Note that any extension |
| | headers present are considered part of the payload, |
| | i.e., included in the length count.) |
| Next Header | 8-bit selector. Identifies the type of header |
| | immediately following the IPv6 header. Uses the |
| | same values as the IPv4 Protocol field [RFC-1700 et |
| | seq.]. |
| Hop Limit | 8-bit unsigned integer. Decremented by 1 by each |
| | node that forwards the packet. The packet is |
| | discarded if Hop Limit is decremented to zero. |
| Source Address | 128-bit address of the originator of the packet. |
| | See RFC 3513 and this document. |
| Destination Address | 128-bit address of the intended recipient of the |
| | packet See RFC 3513 and this document. |

According to an aspect, a received command can be included as extension information in the generated message and/or a generated message packet of the message. The received command for performing an operation by a service based on the command. According to an aspect, a received resource identifier can be included as extension information in the generated message and/or message packet for providing for performing an operation for accessing the identified resource by a service in the zone. For example, the message packager component can be configured for including a received resource identifier in the generated message payload and/or in an extension header of the message packet for storing the resource identifier as extension information for accessing the identified resource.

According to an aspect, at least a portion of a network interface identifier associated with a zone node is received. Further, the network interface identifier is included in a portion of the generated message and/or message packet that is not the network interface portion of the destination portion. The network interface identifier is for routing, from the border node 310, at least a portion of the message to the zone node 314 including the identified ZNNI 320. The border node 310 can optionally interoperate with another zone node for performing the routing to the identified ZNNI 320.

For example, the endpoint communication interface 304 component is configured for receiving at least a portion of the ZNNI identifier associated with the zone node 314. The message packager 208 component can be configured for including, in a portion of the generated message that is not the network interface portion of the destination portion, the ZNNI identifier for detecting by the receiving border node 310 and/or another zone node interoperating with the border node 310 configured for routing the message to the ZNNI 320 of the zone node 314.

Returning to FIG. 1, in block 106 the message is transmitted for routing via a network path outside the scope of the identified zone based on the zone identifier to a border node including an outside network interface for receiving the message and an inside network interface for routing the message to a service. Accordingly, a system for sending information to a zone included in an internet network includes means for transmitting the message for routing via a network path outside the scope of the identified zone based on the zone identifier to a border node including an outside network interface for receiving the message and an inside network interface for routing the message to a service. For example, as illustrated in FIG. 2, the sending network interface component 210 is configured for transmitting the message for routing via a network path outside the scope of the identified zone based on the zone identifier to a border node 310 including an outside network interface 312 for receiving the message and an inside network interface for routing the message to a service.

For example in FIG. 2, the message packager 208 builds a message including the packet header and at least a portion of the message data provided in a payload portion. The message packet can be stored in the same buffer as the data provided to the message packager 208 by the communication interface 202 or can be stored in a new buffer. The message packager 208 can provide the message packet in a buffer to the SNI 210 such as a network interface card (NIC). The SNI 210 supports a protocol of a physical media coupled to the SNI 210. The physical media can be wired or wireless and is included in an internet. The SNI 210 transmits the packet addressed with the outside-scope unicast address to a border node of the identified zone via the internet network.

In FIG. 3, the message packager 208 builds the message packet including the packet header and at least a portion of the message data provided in a payload portion as described above. The message packager 208 of the network layer 206 provides the message packet to a link layer 328. The link layer 328 prepares the packet for transmission by a physical layer 330. For example, the SNI 210 can be an Ethernet NIC included in the sending node 204 including a physical interface to the internet 308. The Ethernet NIC can include a hardware adapter for coupling to an Ethernet Local Area Network (LAN). A typical Ethernet NIC includes firmware implementing a portion of the link layer 328 and hardware components performing operations of the physical layer 330. A remaining portion of the link layer 328 can be provided as a software driver providing an interface to the SNI 210 to other components in the sending node 204. Other configurations of link layers and physical layers are known to those skilled in the art supporting both wired and wireless physical media and a variety of link layer protocols. The link layer 328 can generate one or more link layer frames including the network layer 206 packet. Each link layer frame can be provided to the physical layer for transmission.

The packet is transmitted over the internet 308. The outside-scope unicast address including the zone identifier allows one or more network nodes outside the scope of the identified zone, such as a router in the internet 308, to relay the generated message packet based on the zone portion of the destination outside-scope unicast address. The zone portion identifies the zone 306. Any border node 310 of the identified zone 306 can be defined as a valid destination for delivering the generated message as received in one or more message packets to the identified zone 306. In FIG. 3, the border node 310 includes an ONI 312 as described above.

According to an aspect described above, the message and/or a message packet of the message can include extension information specifying an operation for performing by a recipient service in a border node and/or an identified zone. A message recipient can be a user client and/or component of a node in the identified zone 306, such as the zone node 314, including, but not limited to, any service included in the zone node 314. A zone node and the border node can be the same node depending on the extension information and the configuration of the zone nodes in a zone.

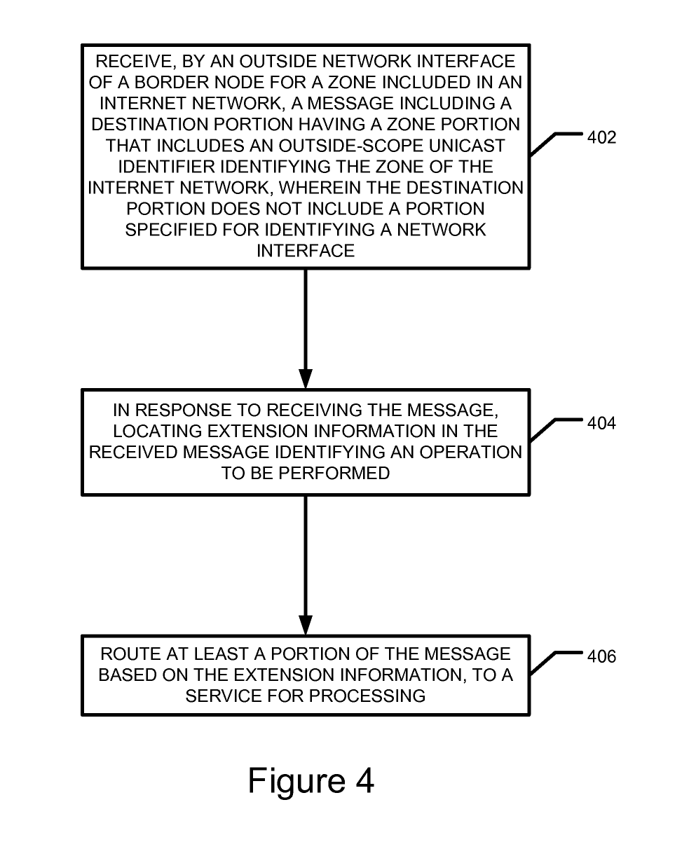

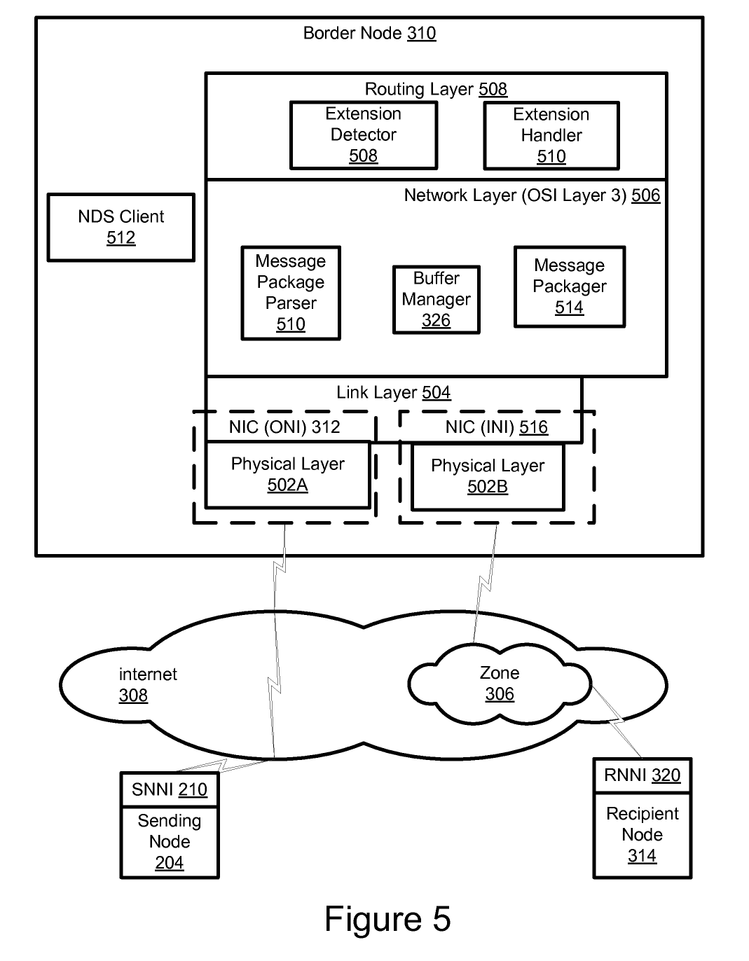

FIG. 4 is a flow diagram illustrating a method for sending information to a zone included in an internet network according to an exemplary embodiment of the subject matter described herein. FIG. 5 is a block diagram illustrating a system for sending information to a zone included in an internet network according to another exemplary embodiment of the subject matter described herein. The method illustrated in FIG. 4 can be carried out by, for example, some or all of the components illustrated in the exemplary system of FIG. 5.

With reference to FIG. 4, in block 402 an outside network interface of a border node for a zone included in an internet network receives an message including a destination portion including an outside-scope unicast address having a zone portion that includes an identifier for the zone of the internet network. The destination portion does not include a portion specified for identifying a network interface. Accordingly, a system for sending information to a zone included in an internet network includes means for receiving a message including a destination portion including an outside-scope unicast identifier having a zone portion that includes an identifier for the zone of the internet network. For example, as illustrated in FIG. 5, an outside network interface (ONI) component 312 is configured for receiving a message including a destination portion including an outside-scope unicast identifier having a zone portion that includes an identifier for the zone of the internet network.

FIG. 5 illustrates the ONI 312 configured for receiving a message. The message is received in one or more packets each including a packet header. The packet header includes a destination portion including an outside-scope unicast address. The destination portion has a zone portion including a zone identifier included in the outside-scope unicast address. The zone identifier identifies a zone 306 of the internet 308. The destination portion does not include a network interface portion specified for identifying a network interface associated with an intended recipient. The ONI 312 need not be included in the identified zone. For example, FIG. 5 depicts the border node 310 including a network interface card (NIC), also referred to as the ONI 312. The ONI 312 includes hardware coupled to a network. A message is received by the ONI 312 via the internet 308 from a sending node outside the scope of the identified zone 306. The message can be transmitted in packets including a packet header with a destination portion for storing the outside-node unicast address as described above.

In FIG. 5, the message is sent from the sending node 204 via the SNI 210 as described above. A packet of the message includes a packet header, for example, as described above in Example 2. The zone portion of the destination portion of the header includes an identifier for the identified zone 306 of the internet 308. The destination portion does not include a network interface portion specified for identifying a network interface, such as the zone node network interface (ZNNI) 320, included in the zone node 314 associated with an intended recipient. The ONI 312 as illustrated in FIG. 5 (and in FIG. 3) need not be included in the identified zone 306.

The ONI 312 can operate in a similar manner to the SNI 210 described above. The ONI 312 can include a physical layer 502A coupled to the internet 308. The physical layer 502A can detect signals received via the internet 308 and can translate the signals into data. The physical layer 502A can pass the data to a link layer 504 analogous to the link layer 330 described above. The link layer 504 detects one or more link layer frames in the data. The link layer 504 processes link layer information in each frame and provides at least a payload of each frame to a network layer 506. Network layer 506 can be compatible with the network layer 206 in the sending device. For example if the network layer 206 is an IP compliant network layer, then the network layer 506 is an IP compliant network layer.

Returning to FIG. 4, in block 404 in response to receiving the message, extension information is located identifying an operation to be performed. Accordingly, a system for sending information to a zone included in an internet network includes means for in response to receiving the message, locating extension information in the received message identifying an operation to be performed. For example, as illustrated in FIG. 5, an extension detector component 508 is configured for, in response to receiving the message, locating extension information in the received message identifying an operation to be performed.

The extension detector 508 can be configured to detect a message received by the ONI 312 and further processed by a link layer and network layer of a network stack included in the border node 310. The extension detector 508 can be configured to locate extension information in the message. The extension information can be located based on a predefined position in the message and/or message packet, based on a marker or indicator in the message and/or message packet, or a combination of the two techniques. The extension information identifies an operation to be performed.

According to an aspect, the extension detector 508 can be configured to locate extension information in a packet header of a packet including the message or a portion of the message as payload data of the packet. In such an aspect, the extension detector 508 can be located in a network layer 506. The network layer 506 receives link layer frame payload data via the ONI 312. The extension detector 508 can be configured to locate the extension information before, during, and/or after detection/reconstruction of the network layer packet. For example, an optional header as described above can be included in a packet header for including extension information. A message package parser 510 can be included in the network layer 506 to detect extension information in a header of a packet. The extension detector 508, when included in the network layer 506, can be a component of the message package parser 510 or can be peer component of the message package parser 510 in the network layer 506. Network layer packets can be examined by the extension detector 508 before, during, and/or after processing of the packet by the message package parser 510.

The network layer 506 detects or reconstructs a network layer packet from payload data in one or more link layer frames. The network layer 506 can be configured to locate the extension information during detection/reconstruction of the network layer packet or after. If a packet does not include a destination portion including an outside-scope unicast identifier in its packet header, it is routed normally.

When extension information is included in a packet's payload data, the message package parser 510 can be configured to discard some or all of the network layer data and pass the remaining data including the payload data to the extension detector 508 depicted in a routing layer 518. The extension detector 508 can be configured to process a message data and/or a packet header and/or packet trailer for locating extension information. As indicated, the extension detector 508 can be configured to locate extension information by position in a packet and/or by an indicator such as predefined keyword, or by using a combination of both methods.

In example 2 above, extension information can be included in an optional header in an IP packet. An optional header in an IP packet is located based on position in the packet and based on a predefined keyword associated with each type of optional header. A keyword for extension information associated with messages sent using a destination outside-scope address can be predefined for indicating the presence of an optional header for extension information. If extension information is not located by the extension detector 508, the message can be discarded. Alternatively, an error response can be returned based on the source address portion of the packet header.

Returning to FIG. 4, in block 406 at least a portion of the message is routed, based on the extension information, to a service for processing. Accordingly, a system for sending information to a zone included in an internet network includes means for routing at least a portion of the message, based on the extension information, to a service for processing. For example, as illustrated in FIG. 5, an extension handler component 510 is configured for routing at least a portion of the message, based on the extension information, to a service for processing.

For example, when the extension detector 508 locates extension information in the message or in a packet including message data or a portion of the message, the extension detector 508 determines a service for processing the message based on the extension information. For example, the extension information may identify an operation to be performed. The operation can be specified by a ZNNI identifier indicating an operation for routing at least a portion of the message to the identified ZNNI included in a zone node in the zone. Alternatively or additionally, an operation can be specified by a command indicator and optional parameters. In yet another example, the operation can be specified as a resource identifier indicating an operation for accessing the identified resource. The IPv6 header depicted in example 2 includes a “Next Header” field. This field can be used to identify an optional header by defining an identifier associated with the extension information. RFC 2460 describes IPv6 extension headers that can be placed between the IPv6 header and the upper layer header in a packet. Those skilled in the art will understand that this technique can be used for any number of network layer protocols. An extension header can be placed, for example, between the last upper layer header in a packet and the payload. It can be treated as part of a header or as payload data in this position.

Example 3 below from RFC 2460 illustrates a network layer header and a transport layer header with an extension header, a routing header, between the two.

### EXAMPLE 3

| | | |
|---|---|---|
| IPv6 header | Routing header | TCP header + data |
| Next Header = | Next Header = | |
| Routing | TCP | |

Example 4 illustrates an extension header format described in RFC 2460.

| | | |
|---|---|---|
| Next Header | Hdr Ext Len | Header Data |

| | |
|---|---|
| Next Header | Identifies the type of header immediately following the |
| | header data. |
| Hdr Ext Len | Length of the Destination Options header. |
| Header Data | Variable-length field, of length specified in Hdr Ext |
| | Len expressed in bytes. |

The extension detector 508 can be configured to determine from a located header identifier an operation to be performed and can route the message to a service depicted as an extension handler 510 configured to perform the identified operation. The extension header data is provided to the extension handler 510 for possible use in performing the identified operation. A border node 310 can perform network protocol operations associated with currently defined extension headers. The use of a destination outside-scope unicast address allows a border node 310 to perform a number of application level operations not currently supported by existing extension or optional headers.

For example, a “unicast extension” header can be defined. The extension information or header data portion can include a zone-local scope name for the ZNNI 320 in the zone 306. The name of the ZNNI 320 can be pliable.nc.sceneralabs.com with an IP address of 192.168.54.17. The outside scope address provided can be the network address corresponding to the subnet 192.168.54.0/255 corresponding to the domain nc.sceneralabs.com. The network interface name, “pliable”, is unique in the identified subnet identified as a zone. The name, “pliable” can be provided in extension information associated with the “unicast” extension. When the extension detector 508 detects the unicast extension and locates the extension information, the extension detector 508 determines a unicast extension handler 510 is associated with the detected unicast extension. The extension detector 508 provides the extension information including the network interface name, pliable. The unicast extension handler 510 is configured to request the resolution of network interface names to determine associated network interface addresses.

In FIG. 5, the unicast extension handler 510 calls a network directory service (NDS) client 512, such as a DNS client providing the name, “pliable”, for resolving the name. The NDS client 512 provides for performing the resolution using an NDS system including an NDS service, such as the DNS system. The NDS client 512 returns the network address of the ZNNI 320. The address can be a complete address or a local scope address such as a zone-local scope address for the zone 306 identified in the outside-scope unicast address of the message header. The unicast extension handler 510 invokes a message packager 514 of the network layer 506 providing information including at least a portion of the received message data and the ZNNI 320 network address. The message packager 514, as described above with respect to the message packager 208 in FIG. 2, is configured to generate a packet. The packet includes a header with a destination portion including the network address of the ZNNI 320. The message packager 514 provides the packet to the link layer 504 generating one or more link layer frames including the packet. The link layer frame or frames are provided to the physical layer 502B of an inside network interface (INI) 516. The INI 516 is either included in the identified zone 306 or is included in a network path from the border node 310 to a network interface of a zone node in the identified zone 306. The message is routed in network layer packets to the ZNNI 320 based on the destination address portion of the network layer packet headers. An example of the transmission of a UDP packet is described below. Thus, the sending node 204 can send a message to the ZNNI 320 associated with a recipient associated with the zone node 314 without requiring the sender to determine the network interface portion of the ZNNI 320 network address.

The source portion of the message header can also include an outside-scope unicast address. Further, the message can include a local scope name for the SNI 210 in a zone identified by a zone portion of the outside-scope unicast address in the source address portion of a packet header received from the sending node 204. This allows the sending node 204 and the zone node 314 to communicate without knowing the network address of their communication partner. The source address can be provided as an outside-scope unicast address by either of the sending node 204 and/or the zone node 314. Alternatively, the border node 310 and/or a border node of the sending node's 204 zone (note shown) can alter the message header so that outside-scope unicast addresses are used in one or both of the source portion and the destination portion of for transmitting a message.

Outside-scope unicast addresses also allow border nodes to become providers of other services as indicated by the examples described above. Extension handlers 510 can be considered applications. An application programming interface can be provided in a border node enabling new applications (extension handlers) to be provided for performing an operation associated with new extension information. For example, an extension handler 510 can provide a proxy function for a service provided by one or more nodes included in the identified zone. This allows the service(s) to be provided to a network node outside the zone 306 without having to provide a network address associated with the network interface of the node in the zone providing the service.

Another use of an outside-scope unicast address described above is to access a resource in a zone 306 identified by the outside-scope unicast address without having to provide a full network address. For example, a datagram or one-way message can be sent to a zone node 314 including a ZNNI 320 included in the identified zone 306. Those skilled in the art will see that a connection oriented communication between the sending node 210 outside the zone 306 and the zone node 314 included in the zone 306 can be provided based on the description of connectionless communication.

Example 5 below depicts a UDP packet header and provides descriptions of each field in the packet header.

### EXAMPLE 5

### UDP Packet Header

| | |
|---|---|
| Source | Destination |
| Port | Port |
| Length | Checksum |

data octets . . .
. . .

User Datagram Header Format Fields
Source Port is an optional field. When meaningful, it indicates the port
of the sending process, and may be assumed to be the port to which a
reply should be addressed in the absence of any other information.
If not used, a value of zero is inserted.
Destination Port has a meaning within the context of a particular internet
destination address.
Length is the length in octets of this user datagram including this header
and the data. (This means the minimum value of the length is eight.)
Checksum is the 16-bit one's complement of the one's complement sum
of a pseudo header of information from the IP header, the UDP header,
and the data, padded with zero octets at the end (if necessary) to make
a multiple of two octets.

Example 6 below illustrates an IP packet header format for including an outside-scope unicast address to deliver a UDP packet to a border node 310 of the identified zone 306. A unicast extension header follows the IP packet header.

### EXAMPLE 6

### IP Packet Including a UDP Packet

| | | |
|---|---|---|
| Version | Traffic Class | Flow Label |

| | | |
|---|---|---|
| Payload Length | Unicast | Hop Limit |
| Source Address | | |

| | |
|---|---|
| 1 1 1 1 1 1 1 1 1 1 | zone |

portion

| unused for addressing or missing portion | | |
|---|---|---|
| UDP | Unicast Length | Node Interface Identifier |

| | |
|---|---|
| checksum | UDP Length |
| Source Port | Destination Port |
| Data Length | Checksum |
| data . . . | |

An extension handler 510 resolves the network interface identifier in the unicast extension header, updates the destination address portion of the IP packet header for delivery to a network interface address determined from the resolving of the network interface identifier. The unicast extension header can be removed from the packet prior to transmitting the packet via the zone 306 to the ZNNI 320. Those skilled in the art will see that delivery of a TCP packet via an IP packet including an outside-scope unicast address operates analogously.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g) or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for sending information to a zone included in an internet network, the method comprising:
receiving zone address information identifying a connected region of topology of a given scope included in an internet network, wherein the scope is a topological span within which a network address is usable;
generating a message addressed to a destination specified by an outside-scope unicast identifier having a zone identifier based on the zone address information, wherein the outside-scope unicast identifier portion does not include a network interface portion specified for identifying a network interface; and
transmitting the message for routing via a network path outside the scope of the identified zone based on the zone identifier to a border node having an outside network interface for receiving the message and an inside network interface for routing the message to a service.

2. The method of claim 1 wherein the zone identifier includes at least one of a zone portion of the network address and a name representing a zone portion of a network node identifier in the zone.

3. The method of claim 1 wherein the message includes a connection header for providing a connection oriented transmission service.

4. The method of claim 1 wherein the message includes a connectionless header for providing a connectionless transmission service.

5. The method of claim 1 wherein the inside network interface is included in a network path communicatively coupling the outside network interface of the border node to a network interface of a network node in the identified zone.

6. The method of claim 1 wherein the outside-scope unicast identifier is formatted to include a network interface portion and an indicator for indicating the network interface portion is not usable for routing the message.

7. The method of claim 1 wherein the outside-scope unicast identifier is formatted without a network interface portion.

8. The method of claim 1 wherein the outside-scope unicast identifier is a local-scope identifier for restricting the routing of the message to a portion of the internet identified by the local-scope identifier.

9. The method of claim 1 further comprising
receiving a network interface identifier identifying a network interface of a zone node in the identified zone; and
including, in a portion of the generated message that is not allocated for the destination outside-scope unicast identifier, the network interface identifier for detecting by the receiving border node and routing at least a portion of the message to the identified network interface of the zone node.

10. The method of claim 1 further comprising including a received command identifier in the generated message for providing for performing by a receiver of the generated message, an operation based on the command identifier.

11. The method of claim 1 further comprising including a received resource identifier in the generated message for providing access to the identified resource.

12. The method of claim 1 wherein the message includes a source address portion having a source zone portion that identifies a source zone associated with the sending entity, wherein the source address portion does not include a network interface portion specified for identifying a network interface of a zone node associated with the sending entity.

13. A system for sending information to a zone included in an internet network, the system comprising:
means for receiving zone address information identifying a connected region of topology of a given scope included in an internet network, wherein the scope is a topological span within which a network address is usable;
means for generating a message addressed to a destination specified by an outside-scope unicast identifier having a zone identifier based on the zone address information, wherein the outside-scope unicast identifier portion does not include a network interface portion specified for identifying a network interface; and
means for transmitting the message for routing via a network path outside the scope of the identified zone based on the zone identifier to a border node having an outside network interface for receiving the message and an inside network interface for routing the message to a service.

14. A system for sending information to a zone included in an internet network, the system comprising:
a communication interface component configured for receiving zone address information identifying a connected region of topology of a given scope included in an internet network, wherein the scope is a topological span within which a network address is usable;
a message packager component configured for generating a message addressed to a destination specified by an outside-scope unicast identifier having a zone identifier based on the zone address information, wherein the outside-scope unicast identifier portion does not include a network interface portion specified for identifying a network interface; and
a sending network interface component configured for transmitting the message for routing via a network path outside the scope of the identified zone based on the zone identifier to a border node having an outside network interface for receiving the message and an inside network interface for routing the message to a service.

15. The system of claim 14 wherein the zone identifier includes at least one of a zone portion of the network address and a name representing a zone portion of a network node identifier in the zone.

16. The system of claim 14 wherein the message includes a connection header for providing a connection oriented transmission service.

17. The system of claim 14 wherein the message includes a connectionless header for providing a connectionless transmission service.

18. The system of claim 14 wherein the inside network interface is included in at least one of the identified zone and a network path communicatively coupling the outside network interface of the border node to a network interface of a network node in the identified zone.

19. The system of claim 14 wherein the outside-scope unicast identifier is formatted to include a network interface portion and an indicator for indicating the network interface portion is not usable for routing the message.

20. The system of claim 14 wherein the outside-scope unicast identifier is formatted without a network interface portion.

21. The system of claim 14 further comprising an endpoint communication interface component configured for receiving a network interface identifier identifying a network interface of a zone node in the identified zone; and wherein the message packager component is configured for including, in a portion of the generated message that is not allocated for the destination outside-scope unicast identifier, the network interface identifier for detecting by the receiving border node and routing at least a portion of the message to the identified network interface of the zone node.

22. The system of claim 14 wherein the message packager component is configured for including a received command identifier in the generated message for providing for performing by a receiver of the generated message, an operation based on the command identifier.

23. The system of claim 14 wherein the message packager component is configured for including a received resource identifier in the generated message for providing access to the identified resource.

24. A computer readable medium embodying a computer program, executable by a machine, for sending information to a zone included in an internet network, the computer program comprising executable instructions for:
receiving zone address information identifying a connected region of topology of a given scope included in an internet network, wherein the scope is a topological span within which a network address is usable;
generating a unicast message including a message header including a destination portion including an outside scope identifier having a zone identifier based on the zone address information, wherein the destination portion does not include a zone network interface portion specified for identifying a network interface of a zone node included in the identified zone; and
transmitting the unicast message for routing based on the zone identifier to a border node having an outside network interface for receiving the unicast message and an inside network interface for routing the unicast message to a service.

25. A method for sending information to a zone included in an internet network, the method comprising:
receiving, by an outside network interface of a border node for a zone included in an internet network, an message including a destination portion having a zone portion that includes an outside-scope unicast identifier identifying the zone of the internet network, wherein the destination portion does not include a portion specified for identifying a network interface;
in response to receiving the message, locating extension information in the received message identifying an operation to be performed; and
routing at least a portion of the message, based on the extension information, to a service for processing.
